(19) United States
(12) Patent Application Publication
(10) Pub. No.: US 2011/0264705 A1
(43) Pub. Date: Oct. 27, 2011

(54) METHOD AND SYSTEM FOR INTERACTIVE GENERATION OF PRESENTATIONS

(76) Inventor: Brandon Diamond, Great Neck, NY (US)

(21) Appl. No.: 12/765,627

(22) Filed: Apr. 22, 2010

(51) Int. Cl. G06F 17/30; G06F 3/01

(52) U.S. Cl. 707/803; 715/730; 707/E17.044

(57) ABSTRACT

Embodiments disclosed include computerized methods and systems for creating slideshow presentations using an outline based programming language. The outline based input is normalized, thereby permitting receipt of the input from devices using different operating systems. A lexical analysis is performed on the input to compile a set of tokens and a hierarchical data structure is created from the set of tokens. A slideshow presentation is created from the hierarchical data structure.

### BACKGROUND OF THE INVENTION

1. Field of the Invention

The present invention relates generally to the creation of documents via a computer, and more specifically, to computer-implemented methods and systems for creating, editing, saving, and viewing slideshows and other presentations and documents.

2. Discussion of Related Art

The personal computer (PC) has led to a revolution in the way presentations have been created. In the past, user interfaces required advanced knowledge of computer programming languages, and so the creation of presentations on computers was solely the domain of skilled programmers. Subsequent programs for creating presentations, such as that described in U.S. Pat. No. 4,864,516, created a system by which unskilled users could add text, image, sound and other elements to basic “blank” presentations.

This has led to the development of a number of current presentation programs (such as those sold under the tradenames of Microsoft Powerpoint, OpenOffice Impress and Apple KeyNote), which allow users unskilled in computer programming to create presentations. These more modern programs use graphical user interfaces to present the user with virtual “slide,” to which text, image, sound and other elements can be added. The collection of these “slides” is then used to create a virtual slideshow. The graphical interface used in the creation and editing of the “slide” is generally made to closely emulate the appearance of the final, finished “slide.”

These types of emulations are often referred to in the art as What-You-See-Is-What-You-Get (WYSIWYG), and for the most part increase user friendliness; for example, by showing how a word processor's text document will look once it is printed out, as it is being typed, the user is able to assess possible changes that may need to be made to the layout. For these presentation programs, WYSIWYG serves a similar purpose; the user can immediately assess the layout of a given “slide” and adjust as desired. However, the WYSIWYG editor is actually a hindrance to a large number of presentation program users. Many users prepare text notes for their presentation, which they then must manually adapt to the slide format. This process can be arduous and time consuming.

There are alternatives to WYSIWYG editors for presentation programs, although these programs are currently less popular. A document markup language primarily used by scholars in academia to create text documents known by the tradename LaTeX can be used to create presentations. Additionally, there are programs which use HyperText Markup Language as well as other general purpose markup languages (including reStructuredText, Markdown, Wikitext, and so forth) to create presentations. However, these types of programs require the user to be skilled in a complex computer language that is not specifically tailored to the creation of slideshow presentations and to integrate disparate tools into complex workflows.

Also, in recent years, web applications have grown in popularity. These are applications that are accessed via a web browser over a network, such as the Internet. Web applications have a number of inherent benefits, including the ability to save on hard drive space and the ability to access files anywhere with network access. There are a number of web applications for the creation of presentations, such as those offered under the tradenames of Google Presently and SlideRocket. While these programs make use of many of the advantages of web applications, they do not adequately exploit the ability of these applications to allow for effective sharing of and collaboration in creating presentations.

Accordingly, a need exists for an improved method and system for generating slideshow presentations.

### SUMMARY OF THE INVENTION

Embodiments of the present invention satisfy the foregoing and other needs. In certain embodiments, a method and system is provided for the interactive generation of presentations by means of an intuitive outline format that is resilient against human error. One embodiment according to the present invention includes a server, such as a web server, and any number of end users coupled to a network, such as the Internet, thereby allowing users to remotely, via any number of different computing devices create, edit and share presentations and other documents.

### BRIEF DESCRIPTION OF THE DRAWINGS

A further understanding of the present invention can be obtained by reference to the embodiments set forth in the illustrations of the accompanying drawings. The drawings are not intended to limit the scope of this invention, but merely to clarify and be illustrative of embodiments of the invention.

FIG. 1 is a schematic illustrating the system architecture according to one embodiment of the present invention.

FIG. 2a is an example of user input using the outline based programming language for creating a new slideshow presentation, according to one embodiment of the present invention.

FIG. 2b is a slide presentation based on the example of FIG. 2a, according to one embodiment of the present invention.

FIG. 2c is a representation of the hierarchical relationships known in the art as a parse tree based on the example of FIG. 2a, according to one embodiment of the present invention.

FIG. 3 is a flowchart illustrating the computer-implemented process of creating a new slideshow presentation, according to one embodiment of the present invention.

FIG. 4 is an illustration of a View Page or an Edit Page user interface, according to one embodiment of the present invention.

FIG. 5 is a flow chart illustrating the process of accessing a pre-existing slideshow presentation, according to one embodiment of the present invention.

FIG. 6 is a flow chart illustrating the process of altering a pre-existing slideshow presentation for which a user does not have full editorial control, according to one embodiment of the present invention.

FIG. 7 is a flow chart illustrating the process of altering a pre-existing slideshow presentation for which a user has full editorial control, according to one embodiment of the present invention.

FIG. 8 is an illustration of possible slide layouts, according to one embodiment of the present invention.

### DETAILED DESCRIPTION OF CERTAIN EMBODIMENTS

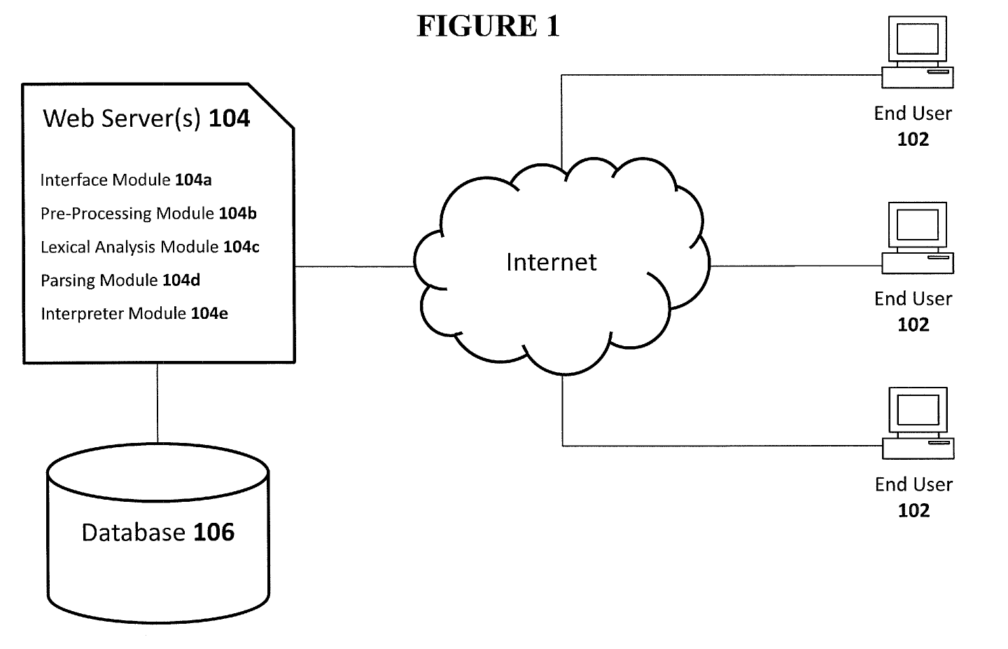

In general, the system according to one embodiment, shown in FIG. 1, includes any number of end user computing devices 102 and at least one computer web server 104 which are coupled to the Internet. As is known in the art, each of the end user computing devices 102 and the web server 104 includes one or more processors that operate in accordance with software, firmware or other computer program stored on a computer readable medium, such as read only memory, hard disks (e.g., in a RAID configuration), tape drives, flash memories, optical disks, network storage or other known or hereafter developed technology. The end user computing devices 102 and the web server 104 (including the processors thereof) may be configured to operate in accordance with software, which may be configured or organized to comprise various functional components or modules.

More specifically, the end user computing devices 102 include a scriptable browser, such as Internet Explorer, Firefox, Google Chrome, Opera, etc. The web server 104 provides the web application disclosed herein, which is accessible by the end user computing devices 102. The web application stored on the web server 104 may be written in any programming language, such as C++, Python, Ruby or any other language, and may consist of a number of discrete modules, including a user interface module 104a for generating the user interface, a pre-processing module 104b for normalizing user input, a lexical analysis module 104c for dividing input into meaningful blocks of data, a parsing module 104d for organizing blocks of data into a hierarchical structure (such as a parse tree), and a interpreter module 104e for translating the hierarchical structure into a final output. Electronic storage or memory having an electronic database 106 is coupled to the web server 104 to store, for example, information pertaining to users, such as user and/or account identifying information, user access rights and authorities, organizational groups for both users and presentation materials, presentation editing history (e.g., by identifying users by e-mail, IP address or unique identifier and storing an indication of the edits made), the slide presentations and user input (outline). Each user's input is also associated or stored with a View Key and an Edit Key, both of which may be alphanumeric sequences which are used to access the input. In general, the web application of the present embodiment provides a web interface that receives from the end user computing devices 102 user inputs and generates new and operates on (e.g., edits, prints, transmits, etc.) existing presentation materials, such as slides, pamphlets, posters and other documents.

It is to be understood that the embodiments of the present invention may be implemented utilizing any number of computer technologies. Although the present embodiments include a web application, where a user (e.g., via the user computing device 102) sends input to a web server 104, which then processes that input and returns to the user a specific output, embodiments of the present invention may be structured as a traditional software application, residing entirely within the electronic memory of one user's computing device including, for example, personal digital assistants, web-enabled cellular telephones, mobile computers, personal computers, and the like. In addition, although the present embodiments relate to providing access to content via the Internet, embodiments of the present invention may be utilized over any computer network, including, for example, a wide area network. Similarly, the end user computing devices 102 may be any device that may be in communication (including constant or intermittent communication) with the network including, for example, personal digital assistants, web-enabled cellular telephones, mobile computers, personal computers, Internet appliances, and the like.

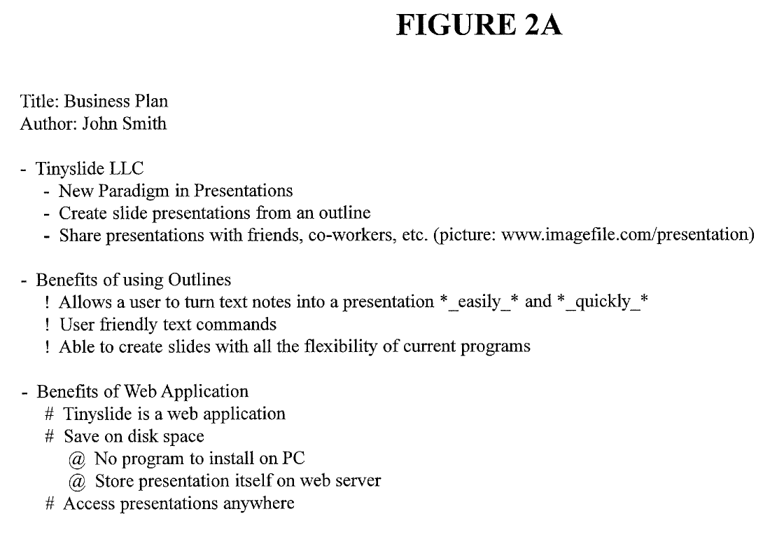

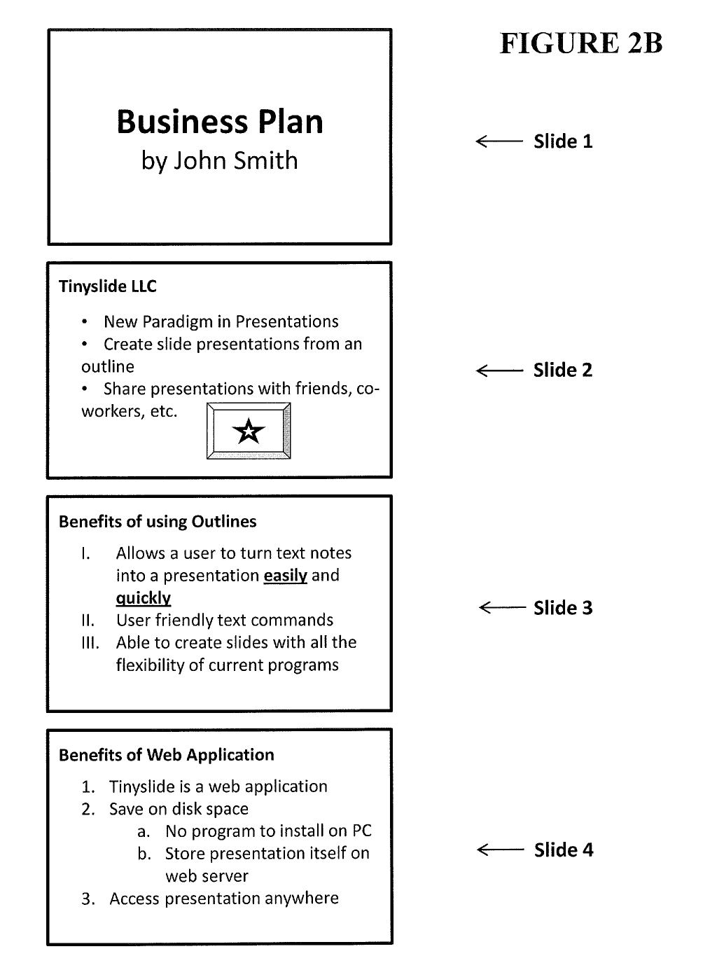

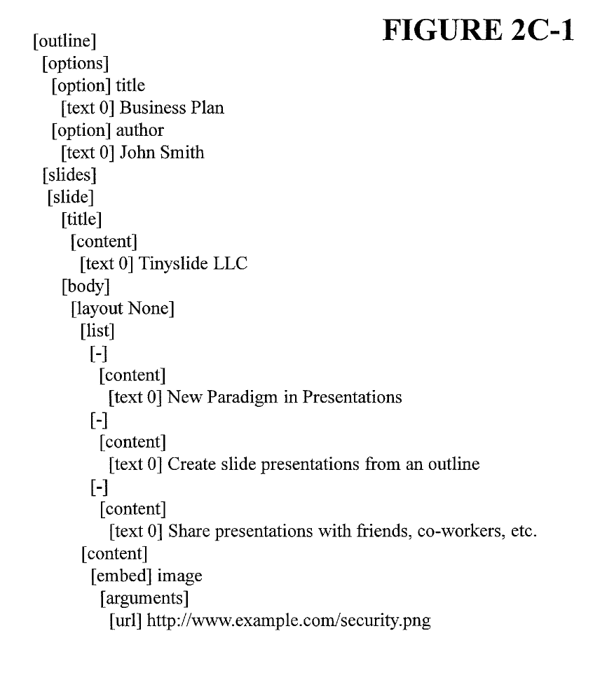

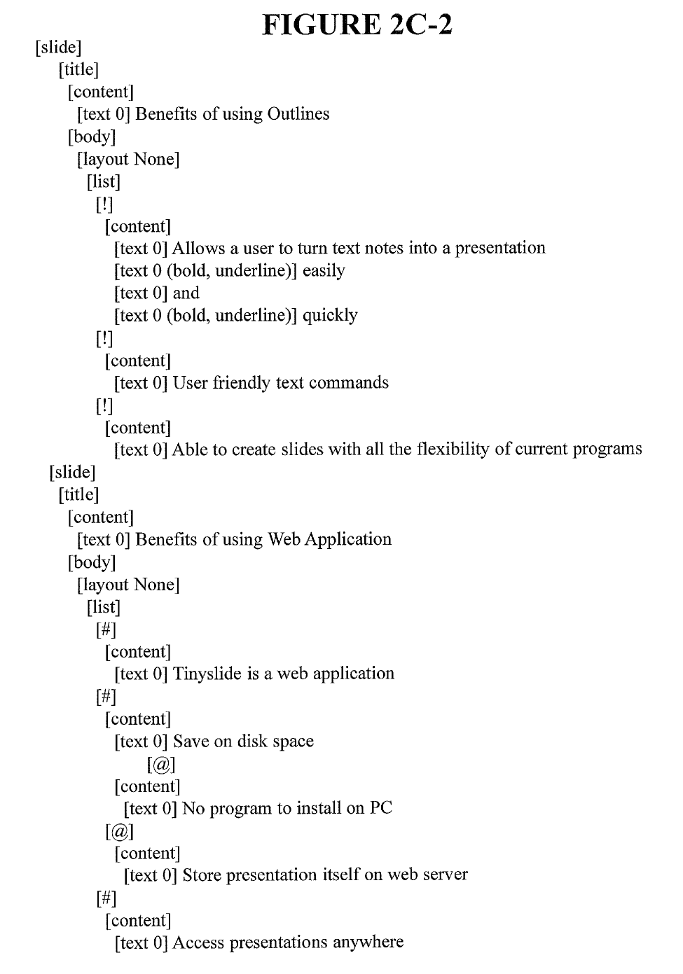

It will be understood that reference to a “connection,” “communication” or “link” is not intended to mean that the various computers be in constant connection or communication, but rather be capable of communication upon establishment of a connection. Rather than using a WYSIWYG editor, embodiments of the present invention use a relatively simple programming language based on an outline format. This language is tailored specifically to the description of slideshow presentations by non-technical users; as such, errors, ambiguities, and inconsistencies are resolved by the system (i.e., application) using high level knowledge of the subject domain. FIG. 2a is an illustrative use of the language of one such embodiment of the invention.

In general, the programming language may permit the user to set parameters for both the overall document, as well as for specific sections and text. For example, presentations may start with any number of special options, represented in the “Option name: value” format, where “Option name” identifies the option and “value” sets the value for such option. These options may include any one or more of the following illustrative options: a title for the presentation, authorship, options for the size of slides, thematic properties affecting the overall appearance of generated slides (discussed below), default text properties, such as font and size, or other option generally relating to presentation properties. The value component depends on the specific option. For example, as shown in FIG. 2a, the user has set the Title of the presentation as “Business Plan” and the Author as “John Smith”. Note that the above discussion characterizes the domain specificity of the outline format; in the present embodiment, options are not general purpose, but highly specific to the task of describing slideshow presentations.

Custom presentation “themes” broadly affecting the overall look-and-feel of the presentation may also be specified via a “theme” option. Theme may affect a wide range of presentational properties including text color, background color, background image, type face, overall slide arrangement and the like. In the present embodiment, themes are implemented via a combination of Cascading Style Sheets, a markup format used to describe the presentational semantics of a document written in another markup format such as the Hyper Text Markup Language, the JavaScript scripting language and digital imagery. Several default themes are provided natively as part of the instant application residing on the system; external themes may be uploaded to the service or fetched from a third-party when the presentation is displayed, as well. Also, some themes may provide additional components of varying types to support and enhance the process of exporting web-based presentations to other presentation formats including those supported by the PowerPoint software program.

In the current embodiment, the programming language includes a marker to delineate different slides (as described more fully below, the dashes at the base level of nesting (often the least-indented dashes in various embodiments) represent different slides) with the instructions following each slide delineator pertaining to each slide. Centered slides are supported by replacing the title character with a special marker, here an equal-sign (=). Text next to each slide-delineating dash (e.g., in FIG. 2a, “Tinyslide LLC”, “Benefits of Using Outlines”) becomes the title of the slide with any text following a single colon on the same line forming a subtitle Titles may be optionally left blank or elided altogether, yielding an untitled slide. Note that any immediately following non-title markup in the outline is regarded as the start of this untitled slide's body. If an untitled slide is followed immediately by title markup, the untitled slide will have no body—it will be blank. This is a “boundary case” that occurs when an outline reads:
Some other slide title
   This will lead to a first, empty slide before a second slide titled “Some other slide title”).

The body of each slide may be associated with spatial coordinates, for example, corresponding to the cardinal and intermediate directions of the compass. In the current embodiment, these are specified using a “location:” marker, where “location” may be replaced with various aliases for the cardinal and intermediate directions, as well as a set of aliases corresponding to the origin or center of the slide. Note that another implementation might specify location using a coordinate or grid-based system. Layout directives are differentiated from similarly structured option specifications because, in the present embodiment, options occur at the start of an outline, whereas layout directives occur within the body of a slide.

The language may also include a marker to denote an item in a list in a slide. For example, indented dashes may create a bulleted list in the slide. In addition to bullets, lists can be made using Roman numerals, common numerals or any other identifiers. Beyond interpreting explicitly enumerated lists, various shorthand list markers may also be supported by the language. In one embodiment, the exclamation mark (!) creates a list denoted with lowercase Roman numerals instead of bullets, while the number sign (#) is used to create a numbered list, and the “at” sign (@) is used to create a list denoted with lowercase letters. In the current implementation, support for definition lists (in which a term or statement is followed by a more detailed definition of the same) is included by means of a “term: definition” format. These constructions are distinguished from the similar option and layout forms by requiring that all terms in a definition list are indented.

The language may also include markers for the emphasis of text which can be altered as well. As seen in FIG. 2a, enclosing text with asterisks (*) will create bolded text and enclosing text with underscores (_) creates underlining. A special marker (\) is included to ignore the special meaning of any single character in the outline; in this way, a user may enter an asterisk character (\*), a dash character (\-) or any other special character in the outline language without invoking the corresponding behavior. In the art, this practice is referred to as “escaping” special characters.

Multimedia can also be added to a presentation. In the present embodiment, the multimedia option is represented in the “Multimedia name: location” format in parentheses, where “Multimedia name” identifies the type of multimedia being embedded within a slide, such as picture video or sound, and “location” identifies an electronic address to be used to obtain the specific multimedia file which, in some embodiments, may take the form of an Internet universal resource locator (URL). For example, in FIG. 2a, the user has embedded a picture in the slide, and that picture is located at www.imagefile.com/presentation.

As will be appreciated by those skilled in the art based on the present disclosure, the present embodiment thus uses a language modeled on basic outlines for the creation of presentations. Further, it should be understood that the foregoing parameters (i.e., presentation options, slide options, text options and multimedia options) and the particular textual markers for such parameters are non-limiting examples according to one embodiment of the present invention. For example, using other, preferably intuitive commands that are similar to a basic outline, a user can create slides and/or text that are justified left, right, center or full-justified, include other types of multimedia files including sound, video, graphs, tables, animation, superscript and/or subscript text, and define other slide and/or text characteristics. It should further be understood that commands may be nested and combined, setting multiple characteristics for any given slide or text. For example, as illustrated in FIGS. 2a and 2b, the same text can be both bolded (*) and underlined (_).

Moreover, note that embodiments of the present invention tolerate a wide range of textual markers and formats even where the user does not employ a uniform syntax of markers and formats. For instance, a list bullet may be denoted by either a dash (-) or an asterisk (*), irrespective of all preceding, as well as subsequent, markers. By tolerating numerous heterogeneous syntaxes, embodiments of the present invention are able to accommodate users who are unaccustomed to traditional markup and programming languages. Thus, the system is capable of supporting users with diverse formatting preferences, as well as users who do not employ a single, consistent format in outlining a presentation.

FIG. 2b is an example of the slide presentation created by the outline in FIG. 2a. The options of Title and Author have created the first slide which lists both the presentations title (Business Plan) and author (John Smith). The second slide is created with the first non-indented dash mark, and titled using the text directly after that dash mark, “Tinyslide LLC.” Below the title is a bulleted list. Below the bulleted list, the picture found at www.imagefile.com/presentation is embedded in the slide. The third slide, again created or delineated using a non-indented dash mark, entitled “Benefits of Using Outlines”, features a list with Roman numerals. Also, the words that were enclosed with asterisks and underscores (“easily” and “quickly”) have been bolded and underlined. The final slide, entitled “Benefits of Web Application”, features a numerated list, with two subcategories to item 2. These subcategories have been structured into a list with letters. It is to be understood that these commands are only samples of the commands used with the preferred embodiment, and that other embodiments could use other commands to generate the same or different characteristics and effects. For example, another embodiment might use an ampersand (&) to create a list using uppercase letters.

As noted above and as described in greater detail below, the present embodiment utilizes a parse tree to create the presentation. FIG. 2c illustrates an example of a parse tree based on the user input of FIG. 2a and used to generate the presentation of FIG. 2b.

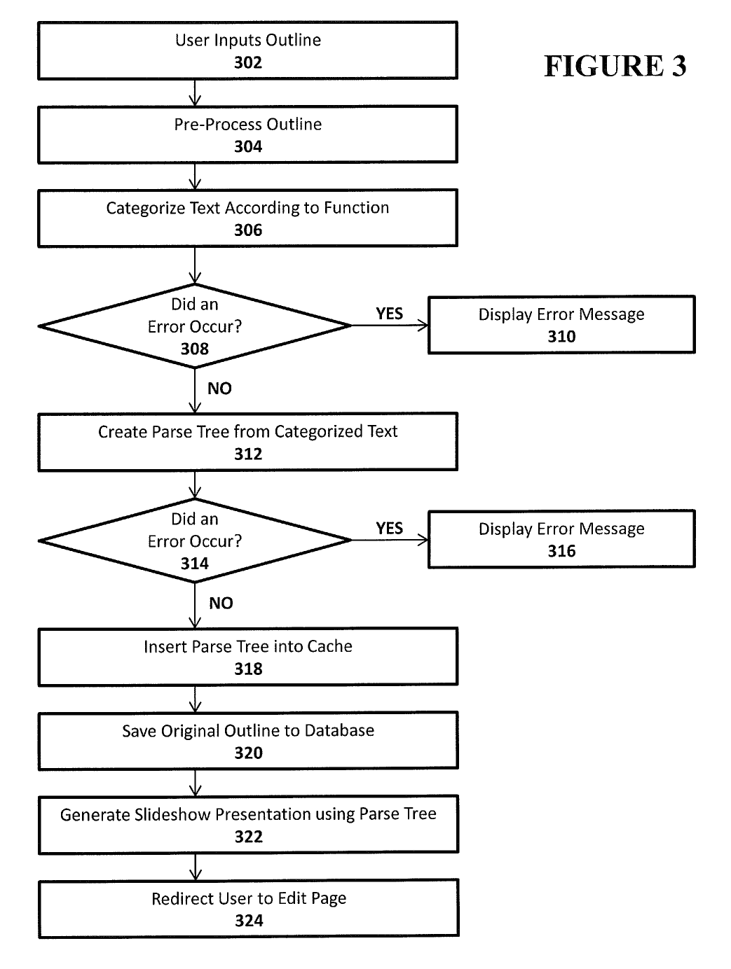

The present embodiment takes the form of a web application for the creation, viewing, and editing of a presentation. The web application may be an application accessed through a web browser over a network, such as the Internet. As such, the user interface may take the form of a web page. A detailed description of how the web application creates a new presentation will now be described with reference to the flow chart of FIG. 3. The user first inputs the outline to the web application 302. In the current embodiment, the user may type the outline into an editor on the web page, or upload a previously saved outline to the web page; however, in alternate embodiments, the user could upload a presentation created with another program (offered under the tradename PowerPoint, for example), from which such embodiment renders an outline by dividing the file into its abstract components (a collection of slides with titles, layouts, and content) and then translating each component into appropriate text for the outline format. For example, many modern presentation authoring utilities, including those offered under the tradenames PowerPoint and Open Office, support file formats based on the XML (eXtensible Markup Language) specification. As a result, these presentation files may be parsed into discrete components corresponding to the higher level entities comprising the presentation using any resource for processing XML files (such as those known under the tradenames ElementTree, MiniDom, and Sax software libraries), whose operations are well known in the art. Once the presentation has been broken down into higher-level entities organized in some embodiments by means of a parse tree, the analogous outline text of the present embodiment can be outputted by systematically interpreting the internal presentation representation via a mechanism similar to the “visitor” pattern described below. One implementation of the importer for importing preexisting presentations utilizes the XSLT (Extensible Stylesheet Language Transformations) XML-based language for transforming presentation XML markup into the outline format.

Once inputted, the application (e.g., pre-processing module 104c) pre-processes the outline 304. This pre-processing normalizes the input by clearing up differences between operating systems and computing platforms. For example, some versions of Windows represent line breaks using two characters, a newline and a return. However, some versions of UNIX and MacOS only use one character such as return or newline. The initial pre-processing alters or normalizes the input so that regardless of which operating system the input originated from, line breaks are represented the same way. For example, the servers 105 are programmed to perform a global search-and-replace that looks for all variations of “NEWLINE” (a carriage return on its own, a carriage return followed by a newline, a newline followed by a carriage return) and replaces them with a single consistent form (here, a single NEWLINE character). Similarly, the servers 105 also convert all “TAB” characters into some number of spaces for ease of processing (it is easier to deal with a single “whitespace” character rather than several). It will be appreciated that because (as discussed below) the outline is a “plaintext” format, the outline does not require other modifications (i.e., normalization). This pre-processing also includes converting the outline to plaintext, if it has been entered in any other format (HTML or Open Document Format, for example). More specifically, while some markup confers meaning (such as bolded text being submitted via an email client that supports bolding and represents it using HTML markup), other markup is irrelevant. A separate software tool or module (e.g., at the server 105) may be used for interpreting the markup (for HTML, one commercially available tool used as part of such interpretation is offered under the tradename Beautiful Soup) and annotating the corresponding input outline with any meaning extracted (for instance, enclosing text with “<b>” and “</b>” in HTML is interpreted to mean that certain text ought to be bold in the final presentation) and simply ignore markup deemed irrelevant (or unrecognized) while extracting the content plaintext. As will be appreciated by those of skill in the art, this permits the user to utilize the features of her email client (e.g., the actual bolding of text), as opposed to utilizing the outline language from such feature (e.g., utilizing asterisks to indicate bold text). The next step is to categorize the plaintext according to function 306; this is a lexical analysis that converts the user-inputted text into a sequence of categorized text, referred to in the art as tokens. Illustrative tokens include:

1. OptionToken: Represents the name of an option;
2. CenterToken: Represents a centered slide;
3. TitleToken: Represents a title;
4. NewlineToken: Represents the end of a line in the outline;
5. LayoutToken: Represents a layout instruction (e.g., “left:” or “north:”);
6. ListToken: Represents a bullet in a list (including alphabetic, numerical, etc);
7. EmbedOpenToken: Represents the start of an embed directive;
8. EmbedCloseToken: Represents the end of an embed directive;
9. ContentTextToken: Represents text appearing on a slide, can contain formatting;
10. RawTextToken: Represents plain text, no formatting; used where formatting is illegal;
11. QuotedTextToken: Represents text that is provided in “quotes”;
12. EmbedTextToken: Represents text in an embed directive;
13. TitleTextToken: Represents text in a slide title;
14. SubtitleToken: Represents the subtitle for a slide;
15. FormatToken: Represents a formatting directive (e.g., * for bold, / for italic, _ for underline);
16. ScaleToken: Represents a scaling value (e.g., used to set the display size of images);

### 17. URLToken: Represents a URL;

18. BooleanToken: Represents either true or false, used for setting options; and
19. EOFToken: Represents the end of the outline.

At this point, the system checks to see if any errors occurred 308 by noting or determining whether any text demonstrated as a token did not actually match the list of possible tokens or, upon deducing a set of potential token classifications, being unable to unambiguously categorize the raw text as one versus the others. In certain embodiments, upon classifying a certain region of text as corresponding to a particular token, various constraints on the text can be verified and an error signaled if the constraints do not hold. For example, an implementation might consider an option token as consisting of alphanumeric text followed by a single colon character. It is possible for the tokenizer to classify a region of text as corresponding to an option token at which point the tokenizer may verify the presence of the terminal colon character. In the absence of the colon, an error can be signaled. If one or more non-recoverable errors did occur, rather than return a presentation, the user would be notified of where the errors are and how to fix them 310.

Further, the system can often recover from errors by leveraging assumptions from the subject domain (more precisely, the specification of slideshow presentations). For instance, should a user attempt to mark text for special treatment (e.g., underline a passage with an underscore character (_) but fail to completely mark the text (e.g., fail to provide a second underscore character to denote the end of the passage to be underlined), the system (i.e., application) will note or identify an error. Rather than notifying the user, however, the present embodiment will simply assume that the entire text passage was intended to be marked (e.g., underlined) and resume interpretation of the outline as otherwise described, effectively ignoring the signaled error. Should the user be dissatisfied with the resulting presentation, he or she may manually fix the error (e.g., insert a terminal underscore where desired).

As another example, if the user has failed to utilize a consistent character for identifying bullet points throughout his or her slideshow, rather than signaling an error, the system will attempt to discern the structure of the slideshow despite the differing characters, perhaps using alternate cues such as indentation as well as best and/or common practices in presentation design to interpret the unexpected input. As an illustrative case, were a user to specify a numbered list in which one or more bullet characters were mistakenly entered as letters, out-of-sequence numbers, or any other unexpected symbols, the system would leverage the knowledge that most slide shows do not incorporate heterogeneous bullet lists (i.e., lists possessing inconsistent and possibly non-sequential bullet characters) to infer that the user had intended all bullets to be numeric and in sequential order. Thus, rather than yielding an error, the system would replace the invalid bullet characters with the appropriate number in the sequence specified.

As another example, if a user has attempted to add multimedia to a slide using the “(Multimedia name: location)” construct, but the user has specified an unrecognized multimedia name or a name that is inconsistent with the media at the location specified, rather than halting generation of the presentation, the system will examine the referenced media and attempt to infer the appropriate media name so as to render the embedded media correctly. If the user had failed to specify the multimedia embedding construct altogether and had instead embedded the location to the media on its own, the system would still be capable of producing a presentation. As it is quite unusual to include the location of media files in slide show presentations, the system will infer that the user had intended to incorporate this media into the presentation rather than its textual location. The system will proceed to examine and normalize the location provided and attempt to infer the type of media to embed from this information alone. If a type is inferred successfully, the media will be embedded accordingly; otherwise, the system will render the location textually. It should be appreciated that in nearly all cases, the system will recover from errors using this strategy of programatically making an assumption to resolve an error.

If there were no errors in the lexical analysis, then the tokens are organized into a hierarchical relationship known in the art as a parse tree 312. FIG. 2c is an illustrative parse tree that has been generated based on the outline of FIG. 2a. As illustrated directly beneath the general heading of “[outline]” come the two options in the outline from FIG. 2a (“[title]” and “[author]”) and the text values (known to those versed in the art as lexemes) associated with them (“Business Plan” and “John Smith,” respectively). Following the options, the next category is “[slides],” in which each of the slides created by the non-indented dashes from FIG. 2a is listed. Beneath each slide, a “[title]” and a “[body]” text are defined. Each [body] also defines a [list], if the [list] uses bullets (represented by “[-]”), roman numerals (represented by “[!]”), numbers (represented by “[#]”), or letters (represented by “[@]”), and the text in the lists. (Of course, some presentations do not have titles, and the body need not contain a list.) Following the symbol demarcating text as text (“[text 0]”), the words in the outline of FIG. 2a that were enclosed with asterisks are marked as bold (“[text 0 (bold)]”). In the current embodiment, this parse tree starts at the broadest (options that affected the entire presentation) and proceed to get narrower (e.g., options for each slide) and narrower (e.g., options for content for each slide). Having created the parse tree, the system again checks for errors (though in some embodiments, errors may be detected while the parse tree is being generated) 314. If one or more errors occurred, rather than return a presentation, the user would be notified of where the errors are and how to fix them 316. As described above, the majority of errors are auto-corrected by relying on assumptions from the subject domain and applying the most reasonable and logical interpretation. If there were no errors, the parse tree is saved to the server's temporary memory (e.g., a cache or electronic memory), 318. Then the original outline that the user input would be saved to a database 220 for later access. When saved to the database 220, the outline may be assigned two numbers: an Edit Key, such as a 16 character alphanumeric sequence and a View Key, which may be a different length than the Edit Key to simplify processing (for example, an as-short-as-possible, preferably no longer than 15 character alphanumeric sequence).

These two keys allow the user to access his/her presentations from the database in the future. The edit key provides full editorial access to the presentation. As such, the edit key ideally is difficult for someone else to determine, to prevent an unauthorized user from gaining the ability to alter a presentation. In the present embodiment, the Edit Key is a randomly generated 16 character alphanumeric sequence. Each character can be either a lowercase letter, an uppercase letter, or a number, providing 47,672,401,706,823,533,450,263,330,816 possible Edit Keys. With this many possible Edit Keys, it would be sufficiently difficult for an unauthorized user to gain access to a presentation with full editorial control. In other embodiments, Edit Keys can be generated by any means that would provide the desired level of difficulty for an unauthorized user to access the presentation.

The View Key provides a user with access to view a presentation: however, in this embodiment, any changes that are made by a user accessing the presentation with a View Key are saved to a new presentation and saved to the database with its own Edit Key and View Key. In the present embodiment, these View Keys can be no longer than 15 characters so that the application can easily distinguish View Keys from Edit Keys. Moreover, View Keys can be as-short-as-possible in order to make them easy to share and remember.

Next, the system generates the web-based presentation from the parse tree 322. Once the hierarchical relationships have been mapped out, the application program “interprets” the parse tree, analyzing each section of the parse tree and performing an operation. This operation depends on the section the program is evaluating. The part of the program performing these operations is known to those skilled in the art as a “visitor.” In general, each visitor implements a single transformation, mapping the parse tree representation to another representation. In the present embodiment, one visitor “visits” each node in the parse tree and outputs the HTML markup (including any CSS markup and JavaScript markup embedded directly or indirectly therein) that corresponds to the presentation on the website. A second visitor “visits” each node and outputs the XML contents of the powerpoint/open document format presentation file (this is an exporter). By defining multiple visitors, the present embodiment is capable of producing slideshow output in any number of distinct formats suitable for any medium upon which the system is implemented. The visitor system effectively constitutes an extensible output mechanism. Lastly, note that the present embodiment does not use a visitor for importing as the import process is concerned primarily with obtaining a tree from a file rather than converting a tree to some other type of output.

At this point in the process, the “visitor” identifies each presentation option node and performs an action based on the properties of that node. The option node “[option] title,” seen in FIG. 2c, results in the creation of a Title slide. Other options invoke different operations and affect the presentation in other ways. Then the program identifies each slide based on the “[slide]” node and, based on the nodes contained within a slide (including “[list]” nodes, “[content]” nodes and nodes nested beneath these), generates HTML that will display the slide. Note that various presentational parameters are computed before HTML markup can be generated for the slideshow presentation. In particular, a concrete hierarchical data structure for any contained lists as well as the appropriate layout to apply to a slide must be identified given the potentially ambiguous specification offered by the user's outline.

To associate a textual list in the outline format with a concrete hierarchical data structure, a “snapping” algorithm is applied. If the degree of indentation of the present list item exceeds that of the immediately preceding list item or if the present item is the first item in the list, a new level is added to the hierarchical list structure. If the degree of indentation of the present list item is less than that of the immediately preceding list item, the present degree of indentation is compared with every preceding degree of indentation. Finally, the current item is “snapped” to the hierarchical level of the most similarly indented list item preceding it. This represents one method for mapping a textual list in the outline format to a concrete hierarchical data structure.

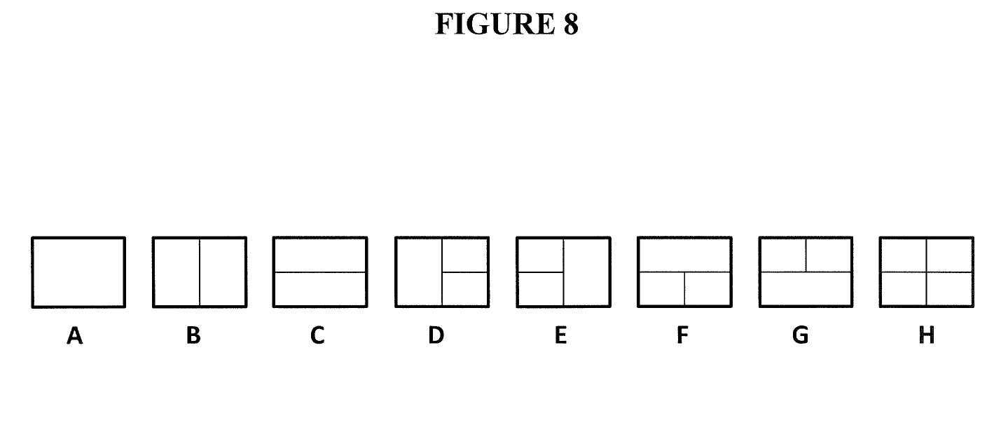

As illustrated with regard to FIG. 8, the layout to apply to a slide is computed from the layout directives specified by the user. In the present embodiment, layout directives do not directly correspond to final slide layouts. Instead, directives associate regions of the slide with particular cardinal and intermediate directions. Thus, some number of slide regions, each associated with a particular location, are mapped to a concrete layout including assignments for each region to sections within that layout. Here, a maximum of four layout directives may be specified for any given slide with any content not having an explicit location being assigned to the “center” region. The present embodiment supports eight distinct layouts which are depicted in diagram of FIG. 8.

In the present embodiment, slide regions are mapped to a layout as follows. First, each region is converted to an equivalent coordinate corresponding to a 3×3 grid wherein each cell corresponds to a cardinal or intermediate direction with the center cell serving as the origin and all cells labeled based on their position relative to the center (i.e., the cell directly above the center cell is associated with north and the cell below and to the right of the center cell is associated with south east). In this way, the system (application) establishes a concrete geometric relationship between cardinal and intermediate directions. The following discussion compares regions using this mapping.

The algorithm is defined in piece-wise fashion. Note that all spatial comparisons in the subsequent discussion are evaluated by mapping layout regions to the aforementioned grid and by applying the Euclidean distance formula to the corresponding coordinates. If one region is provided, layout (A) is selected. If two regions are provided, it is determined whether the regions are more separated horizontally than vertically. If horizontally, layout (B) is selected; otherwise, layout (C) is selected. If three regions are provided, the two closest regions are identified. If the closest two regions differ most from the third region horizontally, either layout (D) or (E) is selected. Otherwise, either layout (F) or (G) is selected. Of the two resulting layouts, one is selected based on the spatial relationship of the two closest points as above, recursively (the subdivided half of the layout is inspected as though there were only the two closest regions to begin with). If four regions are provided, layout (H) is selected. If in any case, points are found to be equidistant, a default layout and content assignment is selected as the user has provided ambiguous input. Finally, over the course of selecting a slide layout, an association between region content and layout section is established by noting the relative position of each region when regions are compared in the steps above.

Once the details of the slide's layout and organization have been computed, the program generates HTML for the title of the slide and the slide's contents based any applicable presentation options, any layout directives, and the user-specified text. Finally, once a web page for the presentation has been generated, the user is redirected to an Edit Page 224. The Uniform Resource Locator (URL), such as “http://www.tinyslide.com/a3d45eef93c81ba5/0”, serves as the address for this Edit Page and includes the 16 character alphanumeric Edit Key. The Edit Page of the present embodiment has both a text editor with the outline, a viewer to display the presentation, and list the View Key. Further details on the Edit Page are discussed below.

It is important to note that the creation of this web presentation is only one of many possible presentation formats. Using the same parse tree, while one “visitor” can generate HTML for a web page, other “visitors” can perform different operations, including but not limited to, the generation of presentations in formats which other presentation programs, such as that offered under the tradename of PowerPoint, can use.

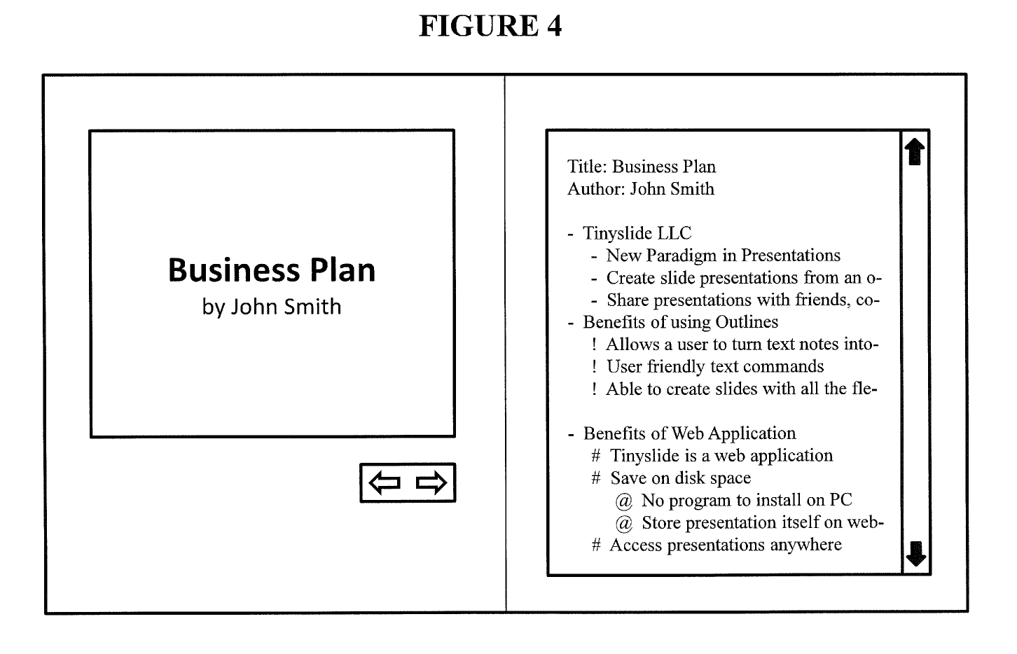

The current embodiment also includes the ability to view and edit presentations by way of the View Page and the Edit Page, which appear identical to the user in this embodiment. FIG. 4 is an illustration of these pages for the example outline of FIG. 2a. The left side displays slides (one at a time) from this presentation. Below this slide are buttons to advance forward one slide or backwards one slide. Other embodiments could include the ability to expand the slideshow to the full size of the screen, the ability to navigate to an arbitrary slide in the presentation, or the ability to view multiple slides at once. The outline that was used to generate the slideshow presentation is retrieved from the database and displayed on the right side of the screen, in a text box. Although both the View Page and the Edit Page appear identical to the user, in this embodiment if a user makes alterations to the outline on a View Page, a new presentation is generated and saved to the database as a different record than the original presentation. If a user makes alterations to the outline on an Edit Page, the previous presentation and outline is overwritten.

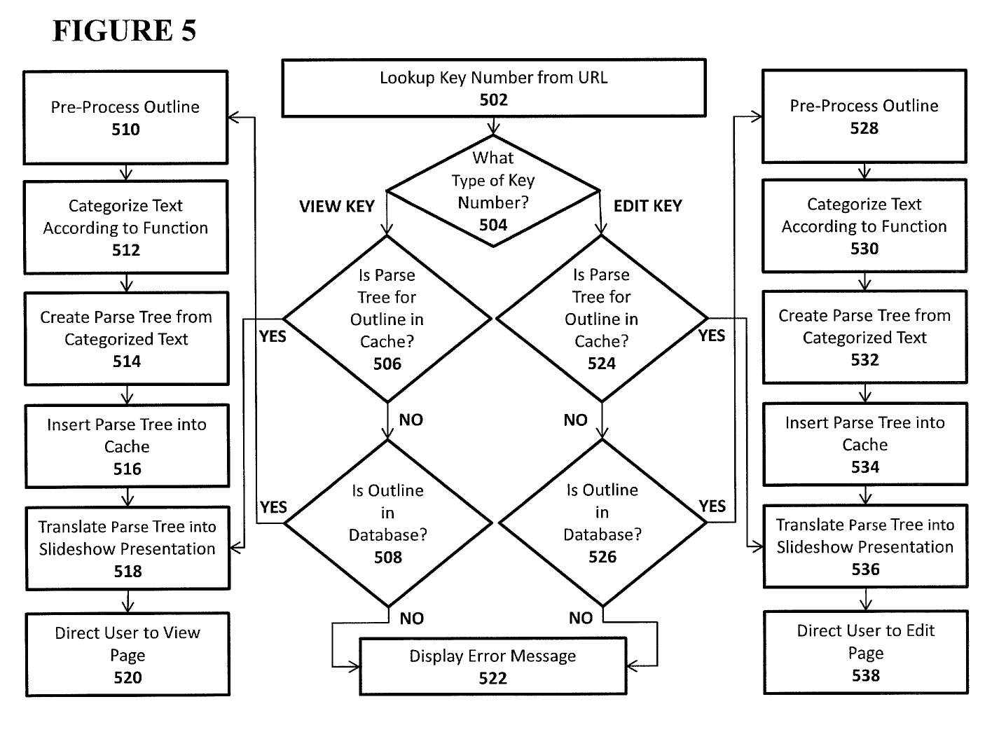

FIG. 5 illustrates the processes involved in the viewing and editing presentations. When a user wishes to access the web application to either view or edit a presentation, he will use one of two URLs previously assigned the application. One URL contains the View Key and one contains the Edit Key. These URLs are generated by the application with the initial presentation, and the user that first created the presentation can distribute either URL to other users at his discretion. The View Page URL may take the form of “http://www.tinyslide.com/a1/0”, where the portion immediately following the exemplary domain name (“www.tinyslide.com”), excluding the forward slash, represents the View Key (“a1”) and the portion immediately following the View Key, again excluding the forward slash, represents the Slide Offset (“0” for the first slide) within the referenced presentation. In the present embodiment, the Slide Offset is optional; if it is not present, the first slide in the presentation (i.e., offset 0) will be shown by default; otherwise, the system (application) interprets the URL and the slide corresponding to the Slide Offset is shown. Edit Page URLs are identical to view page URLs except that they do not include a Slide Offset component and that they embed an Edit Key rather than View Key. The application looks up in the database whichever key sequence is in the URL 502 and determines whether the sequence is a View Key or an Edit Key, for example, based on its length. 504. If the sequence is a View Key, then the web application checks to determine if the parse tree associated with the View Key is currently in the cache 506. If the parse tree is found in the cache, then a “visitor” is used to generate a presentation 518 and the user is directed to a View Page 520. If the parse tree is not in the cache, then the web application checks to determine if an outline associated with the View Key is saved in the database 508. If there is an associated outline, that outline is then pre-processed 510, lexically analyzed in order to categorize the text by function 512, organized into a parse tree 514, that parse tree is inserted into the cache 516, a “visitor” is used to generate a presentation from that parse tree 418, and the user is then directed to the View Page 520. If there is no associated outline, an error message is displayed 522.

The View Page appears similar to the Edit Page: both consist primarily of a text editor to edit the outline, and a viewer to see the presentation. However, while the Edit Page allows one to make changes to the original outline that is saved to the database, the View Page does not. Rather, changes made to an outline from a View Page generate a new outline, saved to the database with a new View Key and a new Edit Key. Note that in some embodiments, authentication schemes as well as other middleware may be incorporated into the workflow to supplement and modify the base functionality described here. For instance, certain embodiments of the system incorporate a password module to require that a user provide a valid password prior to viewing certain “private” presentations.

A similar process is followed if the key sequence is an Edit Key. If the sequence is an Edit Key, then the web application checks if the parse tree associated with the Edit Key is currently in the cache 524. If the parse tree is found in the cache, then a “visitor” is used to generate a presentation 536 and the user is directed to an Edit Page 538. If the parse tree is not in the cache, then the web application checks if an outline associated with the Edit Key is saved in the database 526. If there is an associated outline, that outline is then pre-processed 528, lexically analyzed in order to categorize the text by function 530, organized into a parse tree 532, that parse tree is inserted into the cache 534, a “visitor” is used to generate a presentation from that parse tree 536, and the user is then directed to the Edit Page 536. If there is no associated outline, an error message is displayed 522.

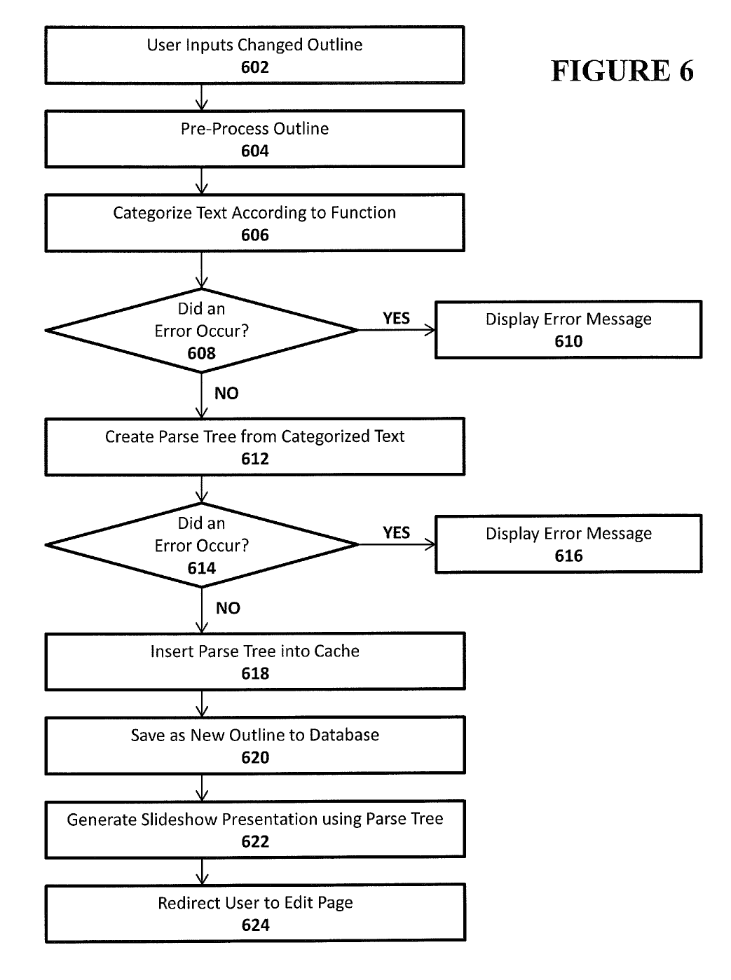

The process of changing an outline from the View Page is described in FIG. 6. The user inputs changes to the outline in the text editor window 602. Once the user submits the changes (e.g., by activating a “submit” button in the View Page or otherwise requests the change be implemented), this changed outline is pre-processed 604 and lexically analyzed in order to categorize the text by function 606. The web application checks to see if an error occurred 608. If one or more non-recoverable errors did occur, rather than return a presentation, the user would be notified of where the errors are and how to fix them 610. If no errors occurred, a parse tree would then be created 612. Again, a check would be performed to see if an error occurred 614. If one or more non-recoverable errors did occur, rather than return a presentation, the user would be notified of where the errors are and how to fix them 616. If no errors occurred, the parse tree would be inserted into the cache 618, and the new outline would be saved to the database with a different View Key and Edit Key than the original outline 620. A “visitor” would then generate a presentation based upon the new parse tree 622 and the user would be redirected to an Edit Page for this presentation 624.

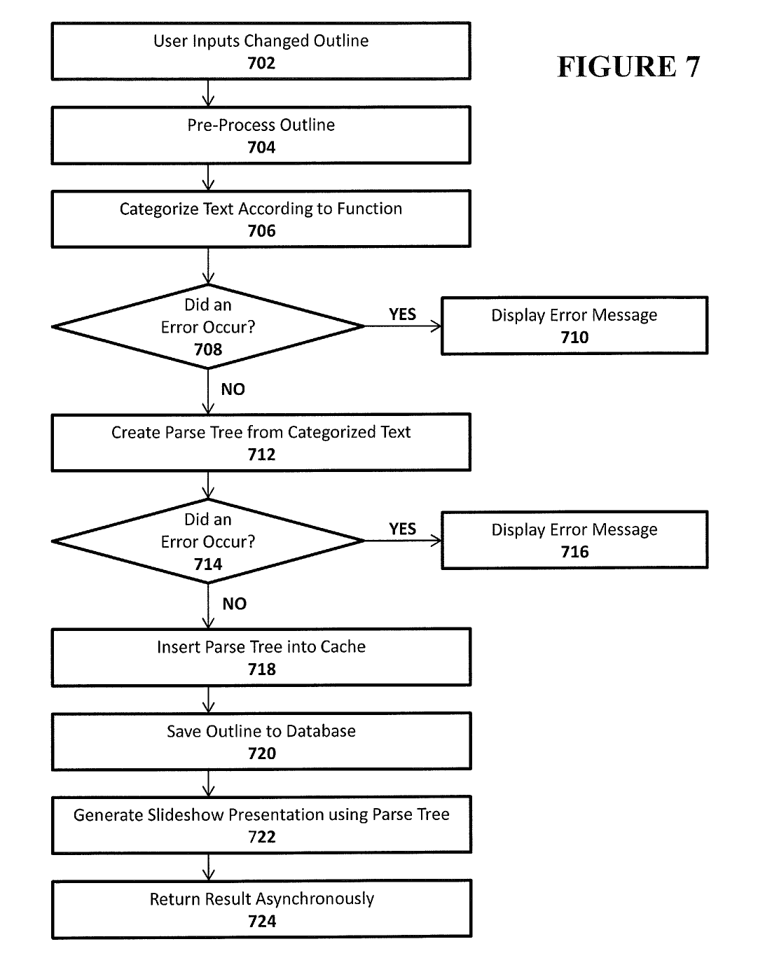

The process of changing an outline from the Edit Page is described in FIG. 7. The user inputs changes to the outline in the text editor window 702. Once the user submits the changes (e.g., by activating a “submit” button in the Edit Page or otherwise requests the change be implemented), this changed outline is pre-processed 704 and lexically analyzed in order to categorize the text by function 706. The web application checks to see if an error occurred 708. If one or more non-recoverable errors did occur, rather than return a presentation, the user would be notified of where the errors are and how to fix them 710. If no errors occurred, a parse tree would then be created 712. Again, a check would be performed to see if an error occurred 714. If one or more non-recoverable errors did occur, rather than return a presentation, the user would be notified of where the errors are and how to fix them 716. If no errors occurred, the parse tree would be inserted into the cache 718, and the new outline would be saved to the database, overwriting the original outline 720. A “visitor” would then generate a presentation based upon the new parse tree 722 and updated presentation is returned to the user.

As stated above, different “visitors” can return presentations not only for web viewing, but also as PowerPoint documents, as Portable Document Files (.pdf), as an Open Presentation format (.odp) (itself a type of the Open Document Format), as a web archive, or as any number of other document types.

By sharing the Edit View link, multiple collaborators can work together on a single presentation. In an illustrative embodiment, the presence and identity of multiple simultaneous editors is indicated by means of a dynamically generated message on the web page. Each user could modify and save the outline at any time. When one user/editor saves the outline, the server(s) will generate a dynamic message on the web page indicating that the outline has changed. This message will contain functionality for loading the updated outline content into the editor. Further, in the embodiment a time stamp indicating the most recent modification saved to the database is compared with the time stamp of the version of the outline currently being edited. If a newer version has been saved to the database since the editor had retrieved the outline from the database, upon saving, the server(s) will attempt to merge the two outlines automatically by computing the textual differences between the two versions. If the modifications do not overlap, the outlines can be merged automatically. If, however, the two versions are in conflict, the user attempting to save will be asked to manually resolve the conflict. In such an embodiment, the Edit View may be altered to indicate that the system is in conflict resolution mode with conflicting sections highlighted in the outline editor. Clicking on the conflicting section causes the conflicting text to be displayed along with an action button to switch between the two conflicting versions of the section automatically.

From the description above, a number of advantages of some embodiments of this system for creating presentations become evident, including but not limited to the those noted above and following:

A. The use of the disclosed outline based programming language, created to be similar to the way many people take notes in preparation for presentations, is faster and easier than the graphical WYSIWYG interface of most other presentation programs, particularly for presentations that are mainly text.

B. By designing the programming language to embody a human-friendly outline format, users need not be skilled programmers to become proficient at the use of this system. The system accommodates a wide range of syntactical constructs and attempts to resolve errors and ambiguity by leveraging knowledge from the subject domain (i.e., the specification of slideshow presentations) rendering it ideally suited for use by non-technical persons.

C. Although this system does not use a WYSIWYG editor per se, a viewer for the presentation is placed next to the text editor, allowing one to retain the advantage of easily verifying and inspecting the final presentation of a slide, while simultaneously eliminating the disadvantages of working with a graphical interface.

D. The View Page and Edit Page take advantage of the ability not only to share information on a network among different users, but also to choose how much information to share. While working collaboratively on a presentation, multiple users can share an Edit Page URL with each other. Alternatively, a single user can share the View Page URL to see how others might change the presentation (as a form of constructive criticism), without losing control of the original presentation and outline.

E. The entire process of (1) describing the contents and appearance of a slideshow presentation based on a human-friendly outline format, (2) examining a preview of that presentation to allow for rapid corrections and modifications, (3) collaborating simultaneously with multiple users, (4) converting said format into an electronic slideshow presentation, and (5) sharing, displaying, and optionally exporting the final presentation to an external format is integrated into a single embodiment rather than an elaborate multiple step workflow utilizing independent tools.

Accordingly, it should be understood that the disclosed methods and systems for the creation of presentations implements a simpler, and more intuitive means of creating rich presentations more efficiently. By using a text based outline to create a presentation rather than a graphical WYSIWYG editor the embodiments are able to generate presentations without requiring the user to do more beyond providing the content of the presentation. And although a graphic “slide” interface is not used in the editor, the placement of a presentation viewer next to the editor allows one to see exactly what the layout of a given slide looks like, and adjust the associated outline accordingly.

Although the description above contains many specificities, these should not be construed as limiting the scope of the embodiments but merely as providing illustrations of some of the presently preferred embodiments. Thus, the scope of the embodiments should be determined by the appended claims and their legal equivalents, rather than being limited by the examples given. In this regard while there have been shown and described fundamental novel features of the invention as applied to the illustrative embodiments thereof, it should be understood that omissions and substitutions and changes in the form and details of the disclosed embodiments of the invention may be made by those skilled in the art without departing from the spirit of the invention. In this regard, it should be understood that the embodiments are merely illustrative, and that the various features and implementations may be combined, interchanged and/or modified. It is also to be understood that the following claims are intended to cover all of the generic and specific features of the embodiments herein described and all statements of the scope of the invention, which, as a matter of language, might be the to fall there between.

I claim:

1. A method for creating slideshow presentations, comprising:
receiving an input in an outline based programming language format;
normalizing the input;
performing a lexical analysis on the input to compile a set of tokens;
creating a hierarchical data structure from the set of tokens; and
creating a slideshow presentation from the hierarchical data structure.

2. The method of claim 1 wherein the input in an outline based programming language format is created from an input in a format other than the outline based programming language format.

3. The method of claim 2 wherein the input in an outline based programming language format is created from a preexisting presentation not created based on the outline based programming language.

4. The method of claim 1 wherein the slideshow presentation is created in HyperText Markup Language format.

5. The method of claim 1 further comprising receiving a preliminary input in another format and generating the input in the outline based programming language format based on the preliminary input.

6. A system for creating slideshow presentations, the system comprising:
a means for receiving an input, that input being in an outline based programming language format,
a server capable of normalizing the input, performing a lexical analysis on the input to compile a set of tokens, creating a hierarchical data structure from the set of tokens, and creating a slideshow presentation from the hierarchical data structure.

7. A system of claim 6 wherein the means for entering an input is a personal computer.

8. A system of claim 6 wherein the means for entering an input is a cellular phone.

9. A system of claim 6 wherein the server is also capable of saving the input for creation of the slideshow presentation at a later date.

10. A system of claim 9 wherein the server is capable of overwriting the saved input.

11. A system of claim 6 wherein the input in an outline based programming language format is created from another type of input.

12. A system of claim 11 wherein the input in an outline based programming language format is created from a PowerPoint formatted presentation.

13. A system of claim 6 wherein the slideshow presentation is created in any one or more of the following: HyperText Markup Language, JavaScript, XML, CSS (cascading style sheets) and image media.

14. A system of claim 6 wherein the slideshow presentation is created in PowerPoint format.

15. A computer readable medium having computer programming thereon for causing one or more processors to create a presentation based on an outline based programming language, the computer programming comprising:
An interface module for causing the processors to provide an interface for accepting input;
A pre-processing module for causing the processors to prepare and sanitize input for conversion into slideshow;
A lexical analysis module for causing the processors to reduce input to discrete tokens suitable for parsing;
A parsing module for causing the processors to extract slideshow structure and properties from sequences of tokens; and
An interpreter module for causing the processors to convert an abstract slideshow representation into a concrete output format.

16. A networked computerized system for permitting end users to generate and view a slide presentation, the system comprising:
an electronic network;
a first end user computing device coupled to the network, the first end user computing device associated with a first end user,
at least a second end user computing device coupled to the network, the second end user computing device associated with a second end user,
a web server coupled to the network, the web server configured in accordance with software in memory to:
generate a presentation in response to receiving from the first end user computing device an input to create the presentation, the input in an outline based programming language;
save the presentation;
assign an edit key and a view key to the presentation;
receive a request from the second end user computing device, the request specifying a key that is either the edit key or the view key;
if the specified key is the edit key, then permitting instructions from the second end user computing device to edit the presentation;
if the specified key is the view key, then providing the second end user computing device a view of the presentation and not permitting instructions from the second end user computing device to edit the presentation.
